(19) United States
(12) Patent Application Publication
(10) Pub. No.: US 2026/0087804 A1
(43) Pub. Date: Mar. 26, 2026

(54) VIDEO MANAGEMENT IN AN INFORMATION PROCESSING SYSTEM

(71) Applicant: Dell Products L.P., Round Rock, TX (US)

(72) Inventors: Shibi Panikkar, Bangalore (IN); Pratheek Veluswamy, Bangalore (IN)

(21) Appl. No.: 18/894,746

(22) Filed: Sep. 24, 2024

(51) Int. Cl. G06V 20/40; G06F 16/735; G06V 10/764; G06V 10/82

(52) U.S. Cl. CPC G06V 20/41; G06F 16/735; G06V 10/764; G06V 20/46; G06V 10/82

(57) ABSTRACT

A method includes extracting a set of frames from a video, detecting one or more contextual attributes in the extracted set of frames, wherein the one or more contextual attributes correspond to contextual attributes associated with a plurality of contextual groups, selecting sample frames from the extracted set of frames for each of the plurality of contextual groups for which the one or more detected contextual attributes correspond, generating at least one classification for the video based on at least a portion of the selected sample frames, and generating a context structure including the one or more detected contextual attributes and the at least one classification for the video.

### FIELD

The field relates generally to information processing systems, and more particularly to techniques for managing videos in such information processing systems.

### BACKGROUND

Existing techniques for video searching include solutions such as a metadata search, a past viewing history search, a visual similarity search, and more recently, an artificial intelligence (AI) based search. Even though these existing solutions yield better searching experiences than predecessor search solutions, each of the existing solutions are still limited as they each require field-by-field comparison. For example, a metadata-based search requires manual tagging of the video with information such as title, file name, objects, and actors in the video. Currently, a user would need to know the metadata key values in order to conduct a content search. However, if some time has passed since the video was tagged with metadata by a user, the user’s recollection of the corresponding metadata may be limited. Thus, the user may give some vague search terms as opposed to searching on the specific metadata (e.g., title, file name, objects, actors, etc.) used to originally tag the video content. Such a vaguely constructed search will likely result in a prohibitive number of search results, e.g., too many results for the user to consider in a reasonable amount of time, or no relevant results at all.

As a result, significant overhead burden is placed on resources (e.g., compute, storage, and network resources) of a computing system on which the search is executed (e.g., the underlying computing system), as well as any other computing systems or devices that support the underlying computing system.

### SUMMARY

Illustrative embodiments provide video management techniques which implement video context creation functionalities in an information processing system.

For example, in one or more illustrative embodiments, a method includes extracting a set of frames from a video, detecting one or more contextual attributes in the extracted set of frames, wherein the one or more contextual attributes correspond to contextual attributes associated with a plurality of contextual groups, selecting sample frames from the extracted set of frames for each of the plurality of contextual groups for which the one or more detected contextual attributes correspond, generating at least one classification for the video based on at least a portion of the selected sample frames, and generating a context structure comprising the one or more detected contextual attributes and the at least one classification for the video.

Further illustrative embodiments are provided in the form of a non-transitory computer readable medium having embodied therein executable program code that when executed by a processor causes the processor to perform the above and/or other steps, operations, and the like. Still further illustrative embodiments comprise an apparatus with a processor and a memory configured to perform the above and/or other steps, operations, and the like. Some illustrative embodiments comprise a system configured to perform the above and/or other steps, operations, and the like.

Advantageously, illustrative embodiments provide, inter alia, a video management system and methodology comprising a video context-based search approach that generates context that is used to classify videos such that subsequent searches can be based on context rather than only static metadata as used in existing approaches.

These and other illustrative embodiments include, without limitation, methods, apparatus, networks, systems and processor-readable storage media.

### BRIEF DESCRIPTION OF THE DRAWINGS

FIG. 1 illustrates a frame extraction architecture according to an illustrative embodiment.

FIG. 2 illustrates pseudocode configured to implement a temporal attention mechanism in a long short-term memory architecture according to an illustrative embodiment.

FIG. 3 illustrates pseudocode configured to implement a video classification process using a long short-term memory architecture according to an illustrative embodiment.

FIG. 4 illustrates an example of a referential context hierarchy created according to an illustrative embodiment.

FIG. 5 illustrates a video management system and process flow with video context creation and search functionalities according to an illustrative embodiment.

FIG. 6 illustrates a set of extracted frames according to an illustrative embodiment.

FIG. 7 illustrates a video management methodology with video context creation and search functionalities according to an illustrative embodiment.

FIGS. 8 and 9 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud and edge computing and storage systems, as well as other types of processing systems comprising various combinations of physical and virtual processing resources.

As mentioned, existing video search is based on manual metadata tagging (e.g., title, file name, objects, actors, etc.). However, the user will oftentimes not remember the name of the video file or any other metadata used to tag the video, especially when the user searches for the video in a video repository many months after the video was tagged. It is realized herein, however, that the user will more likely remember some context about a video such as, by way of example only, the video of an artificial intelligence seminar given by someone in a blue shirt recorded over seven months ago. Unfortunately, existing video search systems do not enable a user to search based on such contexts but rather limit the user to search based on the static metadata terms used to originally tag the video.

Illustrative embodiments overcome the above and other technical drawbacks associated with existing video management approaches by providing a video context-based search approach that generates context that is used to classify videos such that subsequent searches can be based on context rather than just static metadata (e.g., title, file name, objects, actors, etc.). In some illustrative embodiments, video classification is performed based on a trained long short-term memory (LSTM) network and a temporal attention functionality, as will be further described herein.

For example, some illustrative embodiments provide a system and methodology configured to intelligently build video context for a video once the video is committed in a data store (database). More particularly, context can be created using two types of information about the video: (i) static user-supplied metadata (e.g., title, file name, objects, actors, and/or other tags); and (ii) context derived from the video such as, but not limited to, objects, faces, audio, color information, date of creation, and text in the video.

In one or more illustrative embodiments, once a video is committed in a database, and the user opts to enable an intelligent context-based search, a frame extractor is called to optimally extract relevant frames from the video to create the context.

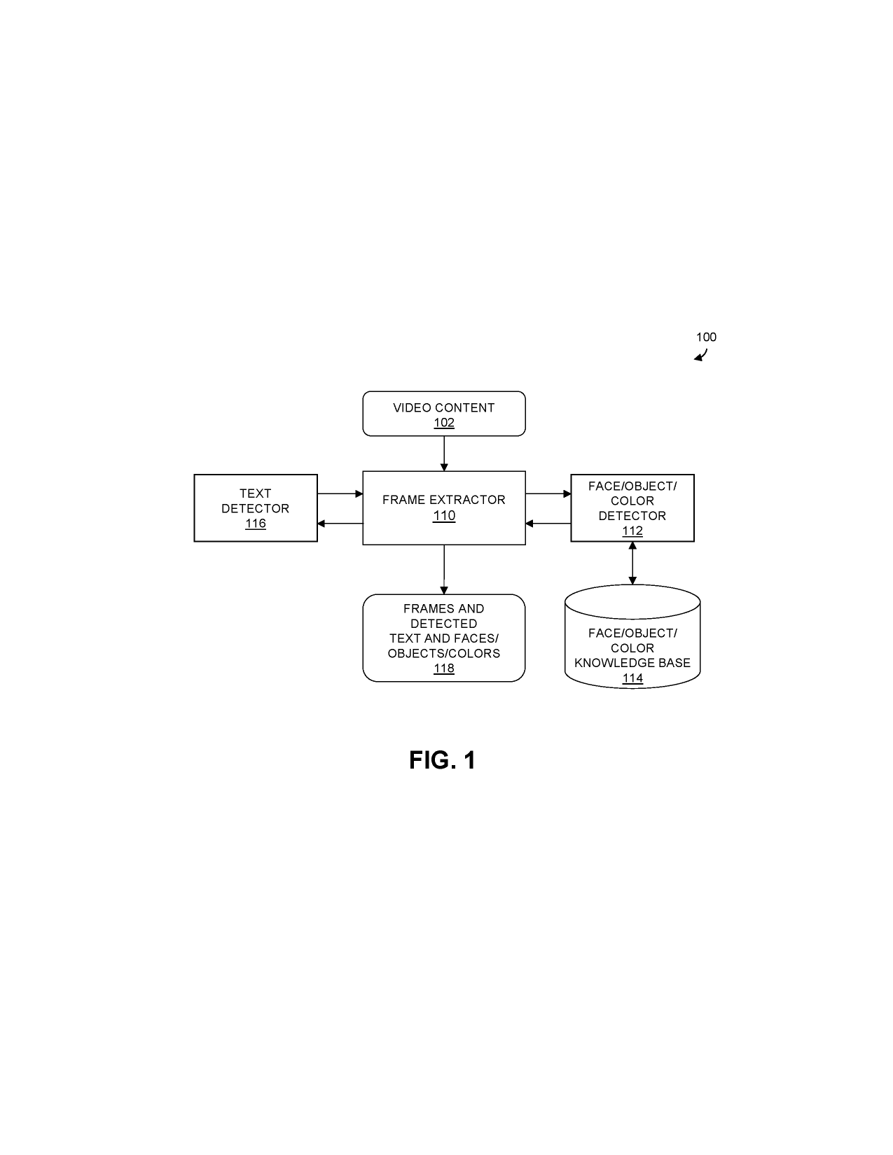

FIG. 1 illustrates a frame extraction architecture 100 according to an illustrative embodiment. As shown, frame extraction architecture 100 includes a frame extractor 110, a face/object/color detector 112, a face/object/color knowledge base 114, and a text detector 116. Video content 102 (at least one video) is input to frame extractor 110 which extracts relevant frames from the video content 102. The extracted frames are provided to face/object/color detector 112 which detects one or more faces, one or more objects, and/or one or more colors from the extracted frames using face/object/color knowledge base 114, e.g., the extracted frames are analyzed for the occurrence of faces, objects and/or colors defined in face/object/color knowledge base 114, and if detected, the faces, objects and/or colors are identified to frame extractor 110. Similarly, the extracted frames are provided to text detector 116 which detects text in the extracted frames. The text is then provided to frame extractor 110. The extracted frames and detected text and detected faces/objects/colors are collectively referenced as 118 in FIG. 1. Non-limiting examples of frame extraction functionality that can be implemented in or otherwise adapted for use in frame extractor 110 include FFmpeg, OpenCV, and the like. OpenCV can also be utilized or adapted in some illustrative embodiments for face/object/color detector 112 and/or text detector 116. Deep neural networks (DNNs) can additionally or alternatively be implemented or adapted for use in face/object detector 112.

More particularly, frame extraction architecture 100 extracts frames (e.g., optimal frames) that appropriately facilitate creation of the context. In one example, frame extraction architecture 100 performs the following: (i) extract frames; (ii) pass the extracted frames to a face detection algorithm; (iii) group frames with the same face; (iv) pass the extracted frames to an object detection algorithm to find the group of frames where the object is the same; (v) pass the extracted frames to a text detection algorithm to find the group of the frames where the text is same; (vi) select the sample frames from each group; and (vii) collect these labelled frames (optimized), as well as the detected face, text, color schemes, and objects in the frames.

Next, given the extracted frames and detected text and detected faces/objects/colors (collectively, 118 in FIG. 1), video classification is performed. In accordance with one or more illustrative embodiments, video classification can be performed using a long short-term memory (LSTM) architecture. In one example, an LSTM architecture is configured to input data such as past and present time series data and generate, based on the time series data, output data such as predicted or future data. An LSTM is a neural network configured to model this type of data computation because an LSTM can learn long-term data dependencies. To make sequence-to-sequence predictions using an LSTM, the LSTM architecture includes an encoder and a decoder. Typically, an LSTM architecture includes two LSTMs, e.g., a first LSTM, functioning as the encoder, that processes an input sequence and generates an encoded state. The encoded state summarizes the information in the input sequence. The second LSTM, functioning as the decoder, uses the encoded state to produce an output sequence.

However, instead of using a typical LSTM architecture as described above, in accordance with one or more illustrative embodiments, a temporal attention functionality is applied which allows the decoder LSTM to process only the most relevant part of the encoded state when generating each step of the output sequence. This is useful, for relatively long videos, given that not all encoder timesteps may be equally informative.

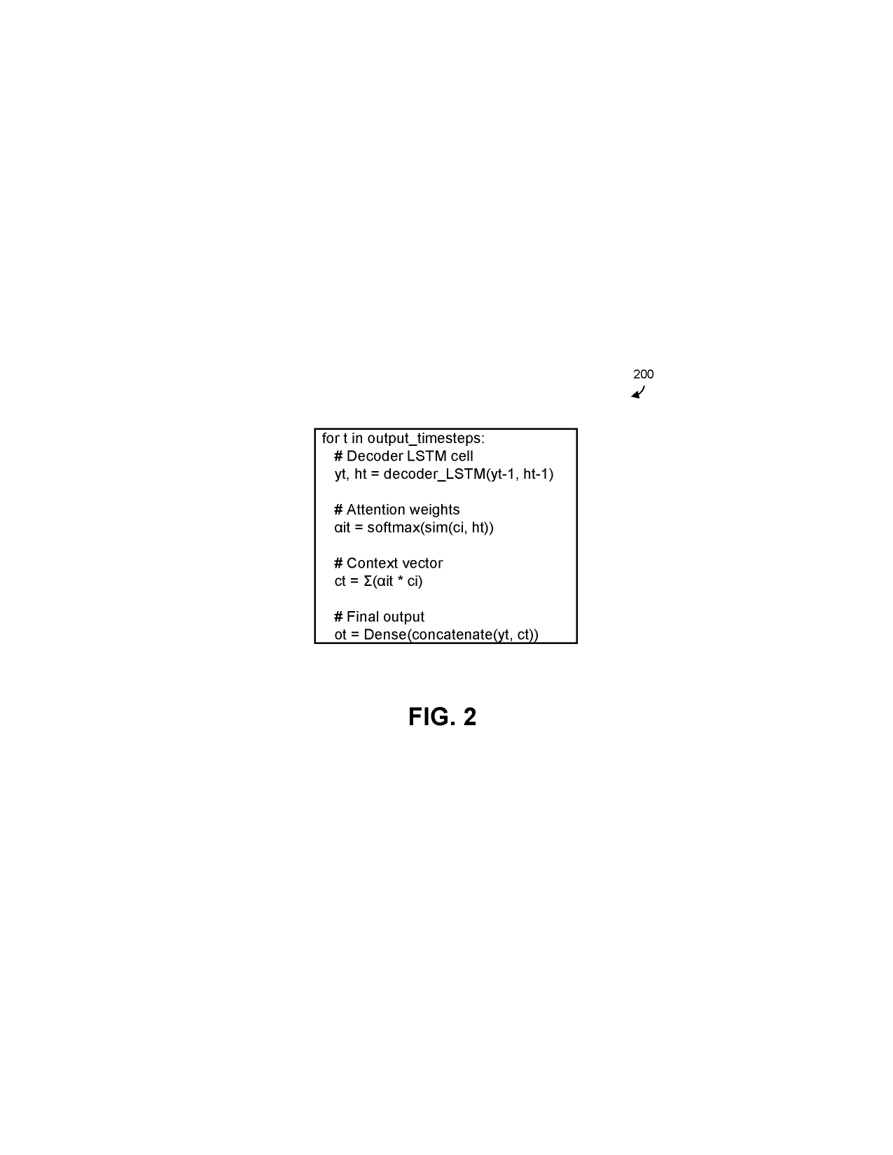

FIG. 2 illustrates pseudocode 200 configured to implement a temporal attention mechanism in a long short-term memory architecture according to an illustrative embodiment. As per pseudocode 200, the encoder LSTM encodes input video frame features into context vectors ci for each timestep i. The decoder LSTM takes the embedding vector at each output timestep yt as input, along with a previous hidden state ht. Attention weights αit are computed between each (ci, ht) pair using a similarity function (e.g., dot product). The context vector ct is computed as the weighted average of ci using the attention weights αit. The context vector ct is concatenated with LSTM output yt and passed through dense layers to make the final prediction. Advantageously, the temporal attention mechanism allows the decoder to dynamically focus on the most useful encoder contextual information when generating each element of the output sequence.

Thus, with respect to video management, an LSTM architecture with a temporal attention mechanism (e.g., pseudocode 200 of FIG. 2) processes the sequence of feature vectors, layer by layer, to learn temporal dependencies and patterns. The LSTM architecture has the ability to retain information over time, enabling capture of long-term dependencies within the video.

The LSTM architecture maintains a sequence-to-sequence mapping. More particularly, the LSTM architecture takes the sequence of feature vectors as input and produces an output at each time step. The final output can be a single classification label for the entire video, or it can be a prediction at each time step, representing per-frame predictions. As described above, a temporal attention mechanism is implemented to enable the LSTM to focus on the most relevant parts of the video sequence for making a classification decision.

During a training phase for the LSTM architecture, the encoder and decoder LSTMs (also referred to as, e.g., LSTM networks or LSTM models) are optimized to minimize a classification error. For example, this may include computing the loss between predicted labels and ground truth labels for training videos and backpropagating the error to update the parameters of the LSTMs. Input frames can be pre-labelled to classify the sequence of frames to labels such as, e.g., Movie, Presentation, Documentary, Short Video, Training Video, etc.

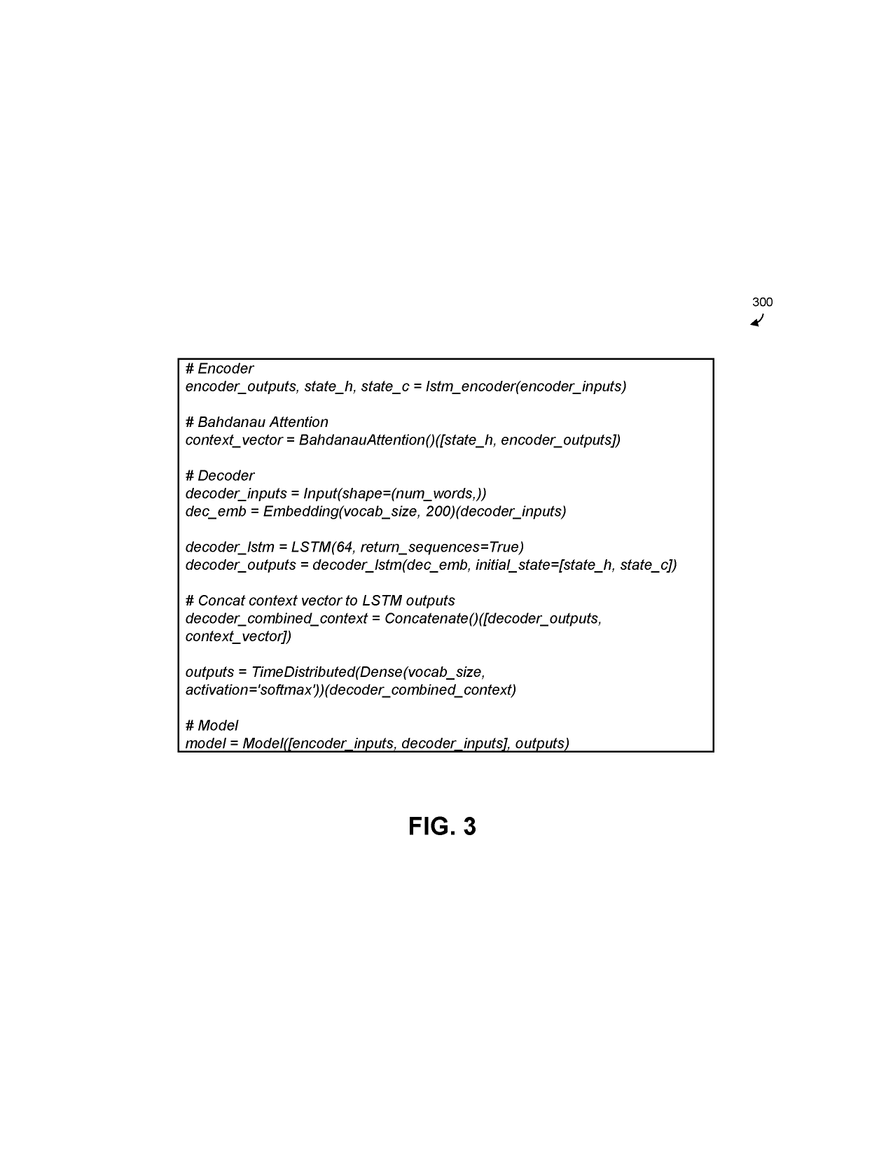

Once the LSTM architecture is trained, it can be used for video classification. New video sequences are passed through the LSTM architecture, and the output provides the predicted class label(s) for the video. FIG. 3 illustrates pseudocode 300 configured to implement a video classification process using a long short-term memory architecture according to an illustrative embodiment.

Advantageously, the LSTM architecture according to one or more illustrative embodiments effectively models the temporal dynamics of video sequences, enabling capture of patterns and dependencies that facilitate accurate video classification. The LSTM architecture according to one or more illustrative embodiments can process sequences of varying lengths, making it adaptable to videos of different durations. The LSTM architecture according to one or more illustrative embodiments considers the context of each frame within the video, which facilitates an understanding of the overall video content and contextually relevant classification. Pre-trained LSTMs or LSTM-based models can be fine-tuned on specific video classification tasks, leveraging knowledge from large-scale datasets and improving performance on smaller, task-specific datasets.

Further, in one or more illustrative embodiments, the audio of the video is extracted and converted to text (e.g., text detector 116 in FIG. 1). In some illustrative embodiments, this can include tokenizing a word and removing the connecting words such as “and,” “the,” etc. Nouns are taken out and a term frequency-inverse document frequency (TD-IDF) method can be used to find relevant key words.

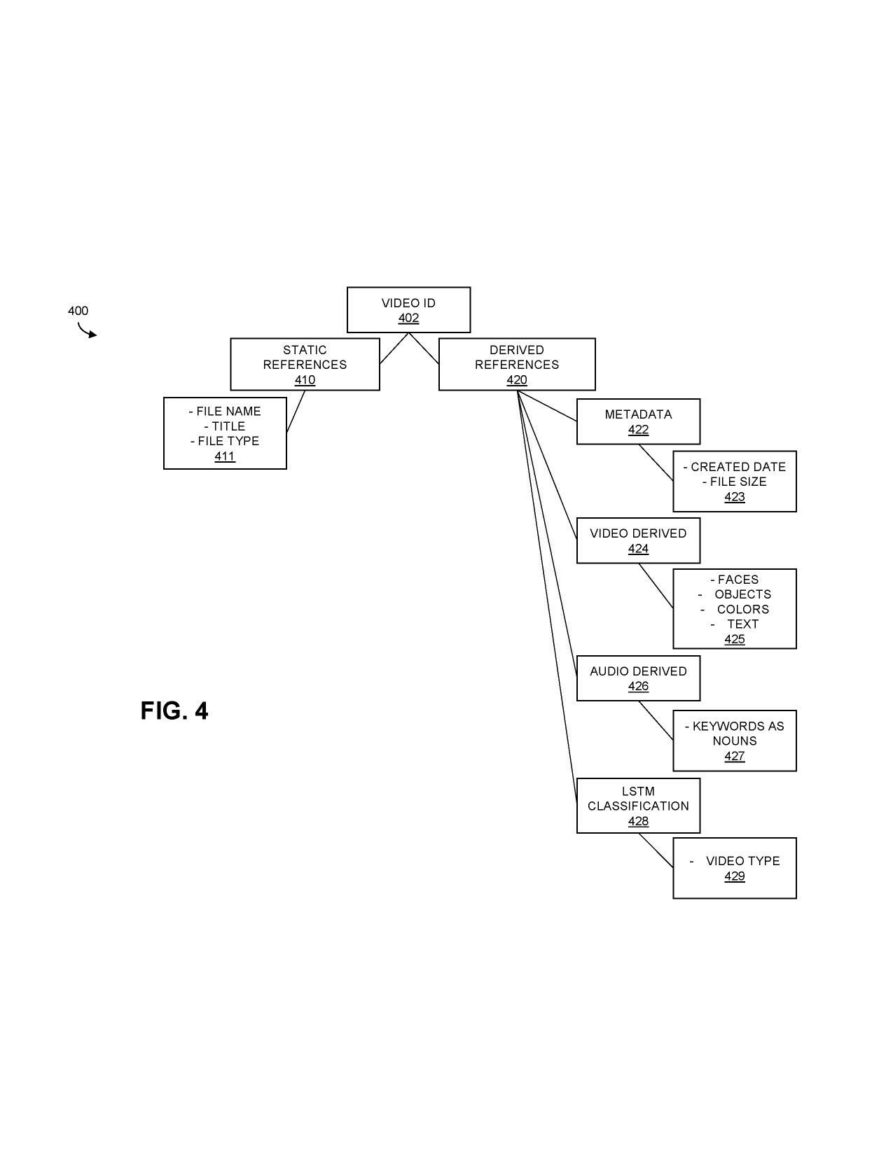

Given a portion or all of the information processed and generated so far, a video context builder creates a hierarchical reference. By way of example, FIG. 4 illustrates a referential context hierarchy 400 created according to an illustrative embodiment. As shown, for a given video identified by a video identifier (ID) 402, the video context builder generates static references 410 and derived references 420. Static references 410 can include references 411 such as file name, title, and file type for the video. Derived references 420 can include: metadata references 422 including references 423 such as created date and file size; video derived references 424 including references 425 such as face, objects, colors, and text; audio derived references 426 including references 427 such as keywords as nouns; and LSTM classification references 428 such as a video type reference 429.

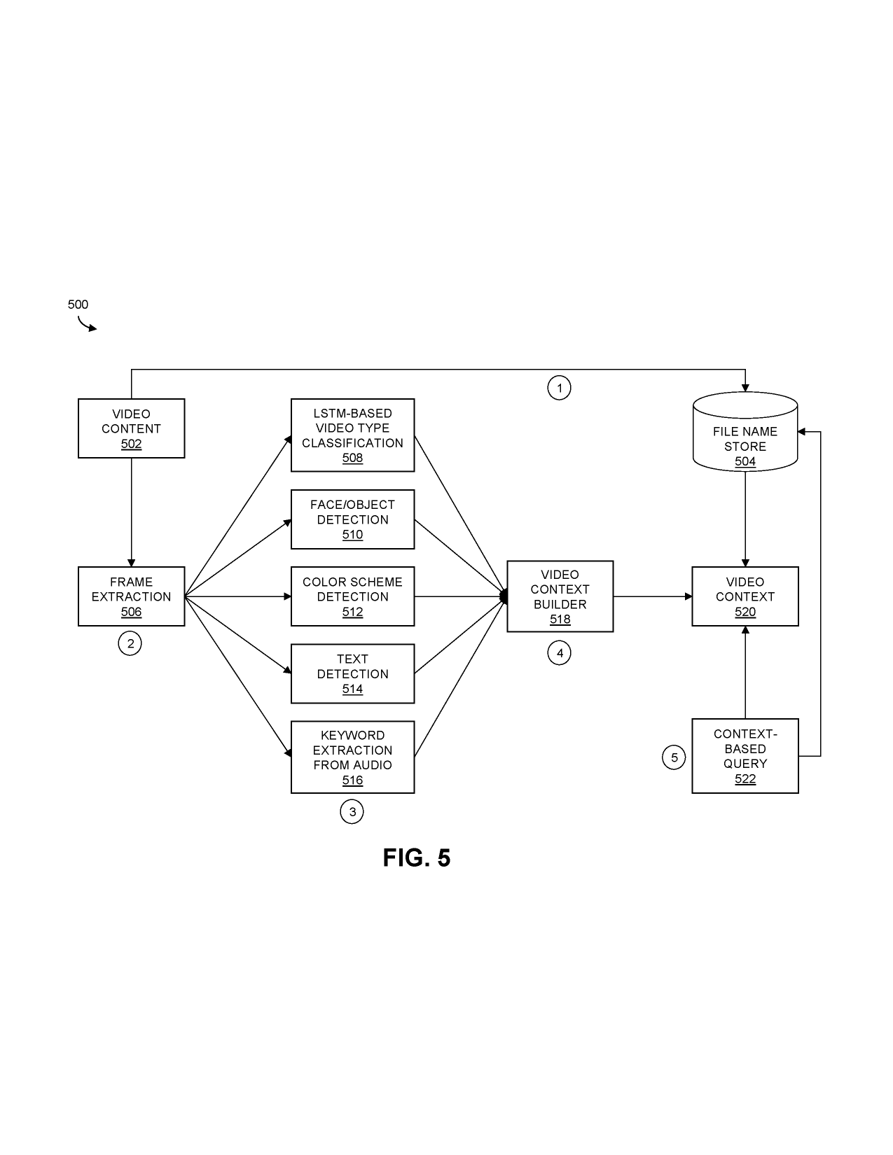

Advantageously, when a user cannot remember the file name or video tag, the user can give some context known to them, e.g., the video of an artificial intelligence seminar given by someone in a blue shirt recorded over seven months ago, and the system can search using the context and locate the correct video. Further details on how such a video context creation and search can be performed according to an illustrative embodiment are described in accordance with FIG. 5.

FIG. 5 illustrates a video management system and process flow 500 with video context creation and search functionalities according to an illustrative embodiment. As shown, in step 1, video content 502 (e.g., at least one video) is stored by file name in a database, e.g., file name store 504. In step 2, video content 502 is provided to a frame extraction module 506 (e.g., frame extractor 110 in FIG. 1). In step 3, the extracted frames are provided to an LSTM-based video type classification module 508, a face/object detection module 510, a color scheme detection module 512, a text detection module 514, and a keyword extraction from audio module 516. Modules 510 through 516, in some embodiments, can be implemented as described above with regard to detectors 112 and 116 in FIG. 1, or in separate modules as shown in FIG. 5. Module 508, in some embodiments, can be implemented using pseudocode described above with regard to FIGS. 2 and 3. Outputs from modules 508 through 516 are provided to a video context builder 518, in step 4, which generates video context 520. In step 5, a user may search for a video (e.g., video content 502) using a context-based query 522.

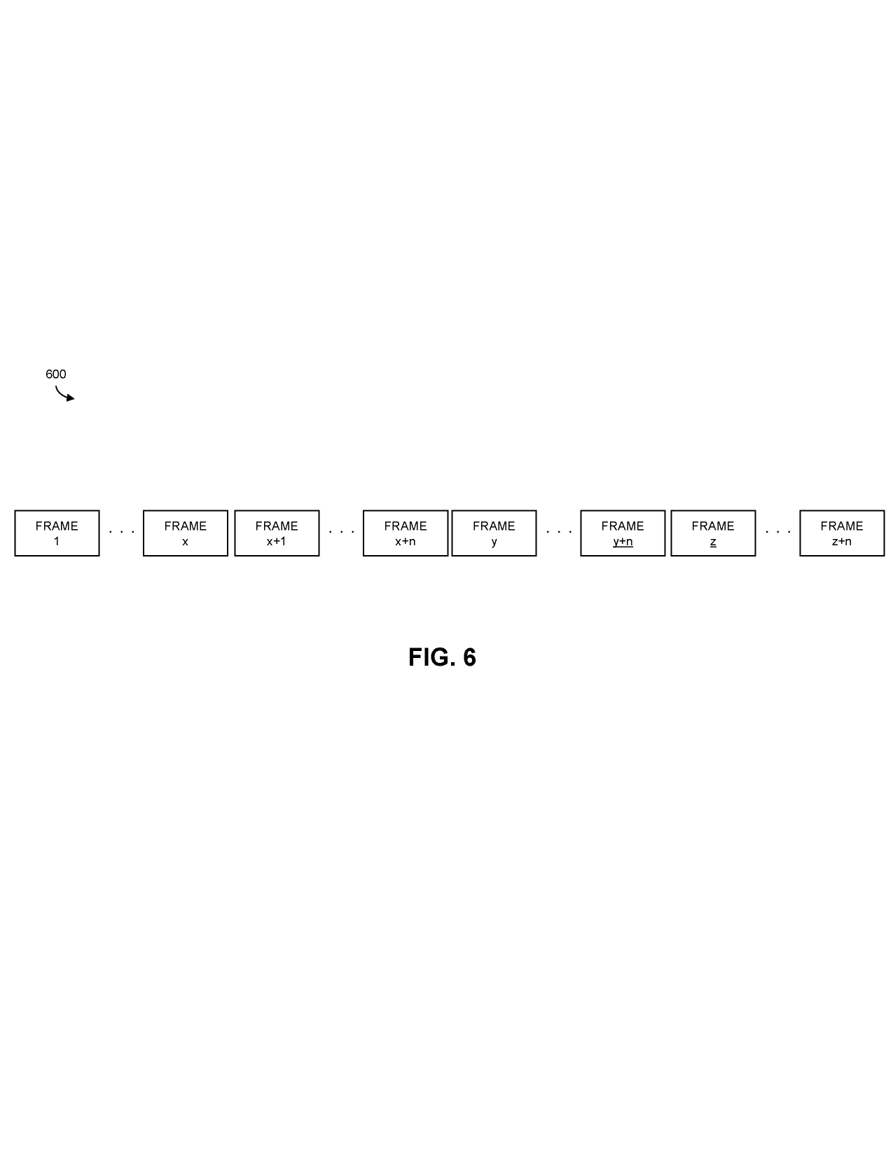

Now consider a non-limiting use case. Assume a video is recorded of a talk hosted by John Smith in front of a screen with a blue background and the words “Artificial Intelligence Seminar 2023” where a speaker Mary Jones from Company A subsequently joins John Smith in front of the screen. In accordance with video management system and process flow 500, the frame extraction module 506 extracts optimized frames from the video. FIG. 6 illustrates an extracted set of frames 600 including frames 1 through x, x+1 through x+n, y through y+n, and z through z+n.

Further assume that for the first x frames, John Smith talks with some background information. Accordingly, face/object detection module 510 identities “John Smith” (using a face knowledge base). Color scheme detection module 512 detects background color is “Blue.” Text detection module 514 detects “Artificial Intelligence Seminar 2023” in the first x frames.

Video management system and process flow 500 selects four sample frames from the first x frames (1 through x). In some illustrative embodiments, the number of sample frames to be selected is configurable.

In x+1 frame, assume the text is changed to “Company A.” Video management system and process flow 500 detects the new text and also selects four sample frames from the frame group x+1 through x+n. Again, in some illustrative embodiments, the number of sample frames to be selected is configurable.

In frame y, assume that the text on the screen changes to display “Mary Jones.” Video management system and process flow 500 detects the new text and a new object (e.g., person) but assume video management system and process flow 500 cannot detect her face yet. Video management system and process flow 500 selects four sample frames from the frame group y through y+n. Again, in some illustrative embodiments, the number of sample frames to be selected is configurable.

In Frame z, video management system and process flow 500 system recognizes the face of “Mary Jones”. Video management system and process flow 500 selects four sample frames from the frame group z through z+n. Again, in some illustrative embodiments, the number of sample frames to be selected is configurable.

Now, the information detected above is passed to one or more trained LSTM models (e.g., LSTM architecture) to determine the video type. Assume the one or more LSTM models return “Presentation” as the video type.

Video management system and process flow 500 then builds the context against the video. The context may include static references (recall as described above with regard to FIG. 4) generated and stored such as: (i) File Name – JohnSmithAIS2023.mpeg; (ii) Title – John Smith at AIS 2023; (iii) File Type – mpeg. Also, the context may include derived references (recall as described above with regard to FIG. 4) generated and stored such as: (i) metadata references including Created Date – 21-09-2023 and File Size – 230 MB; (ii) video derived references such as Face – John Smith, Mary Jones, main background color – blue, clothing color – blue and white for John Smith and green and white for Mary Jones, and text - “Artificial Intelligence Seminar 2023” and “Company A”; and (iii) audio derived references including “Artificial Intelligence” and any relevant keywords; and (iv) LSTM classification including “John Smith Presentation” and “Artificial Intelligence Seminar 2023.”

Now assume a user is trying to recollect this video and tried to search in a video repository in which the video was previously stored using a contextual query “video of an artificial intelligence seminar given by someone in a blue shirt recorded over seven months ago”. In existing video search solutions, the user will receive a prohibitively large number of search results and possibly the correct video appearing several pages into the search results.

However, in accordance with video management system and process flow 500, the same query will be searched against the video context previously generated for this video and will result in the intended video being returned in at or near the top of the search results. In some illustrative embodiments, a large language model (LLM) can be used to parse the query and understand the intent and keywords of the query. Then, using the keywords generated by the LLM, the video repository can be searched, which contains contexts for the videos stored therein, and the video that best matches the contextual query will be returned more accurately than is the case with existing search solutions.

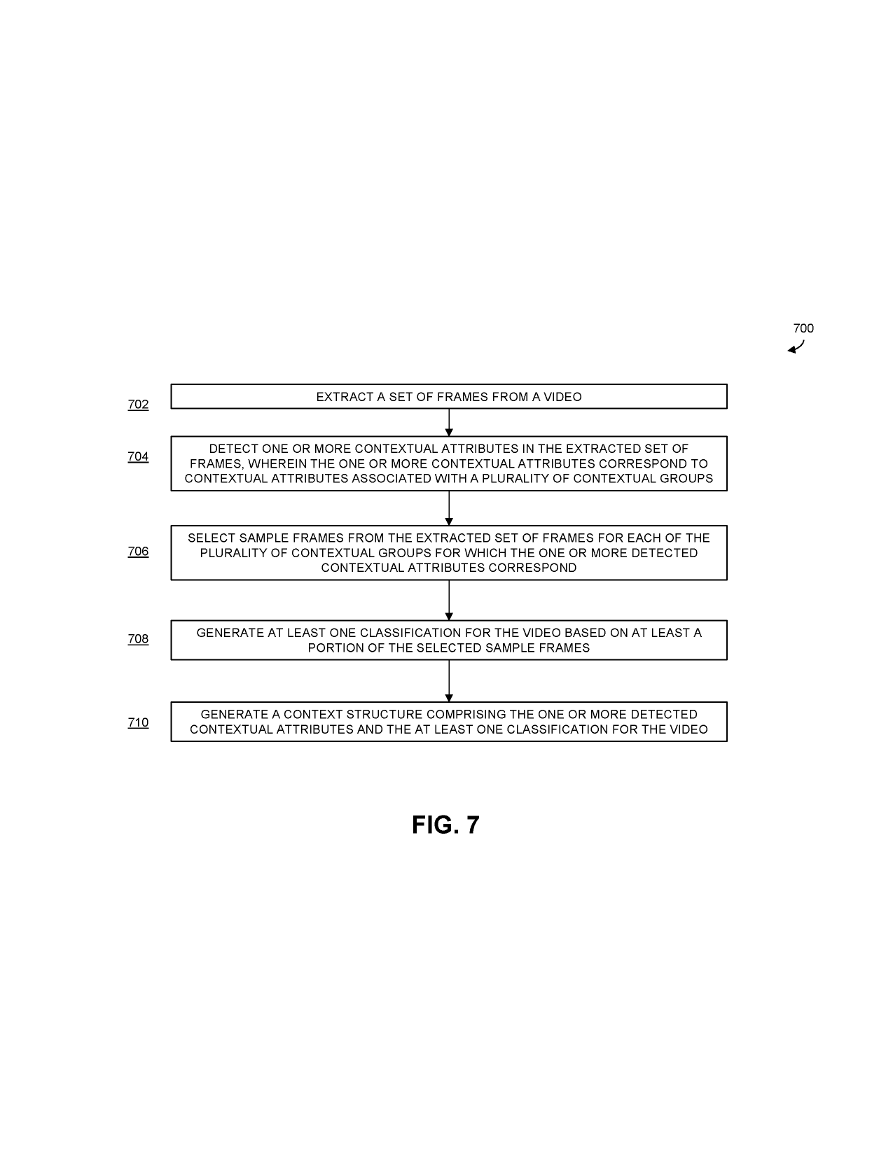

FIG. 7 illustrates a video management methodology 700 with video context creation and search functionalities according to an illustrative embodiment. More particularly, step 702 extracts a set of frames from a video. Step 704 detects one or more contextual attributes in the extracted set of frames, wherein the one or more contextual attributes correspond to contextual attributes associated with a plurality of contextual groups. Step 706 selects sample frames from the extracted set of frames for each of the plurality of contextual groups for which the one or more detected contextual attributes correspond. Step 708 generates at least one classification for the video based on at least a portion of the selected sample frames. Step 710 generates a context structure comprising the one or more detected contextual attributes and the at least one classification for the video.

In some embodiments, the method may further comprise utilizing the context structure to respond to a contextual query searching for the video.

In some embodiments, the plurality of contextual groups comprise a text-oriented contextual group, a face-oriented contextual group, an object-oriented contextual group, and a color-oriented contextual group.

In some embodiments, the one or more detected contextual attributes comprise one or more of text appearing in the video, a face appearing in the video, an object appearing in the video, and a color appearing in the video.

In some embodiments, generating the at least one classification for the video based on at least a portion of the selected sample frames may further comprise utilizing a long short-term memory architecture to predict the at least one classification.

In some embodiments, utilizing the long short-term memory architecture to predict the at least one classification may further comprise implementing a temporal attention mechanism in the long short-term memory architecture to focus on the most relevant parts of the video for making a classification decision.

In some embodiments, generating the context structure comprising the one or more detected contextual attributes and the at least one classification for the video may further comprise generating a referential context hierarchy comprising one or more metadata derived contextual references, one or more video derived contextual references, one or more audio derived contextual references, and one or more video classification references.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

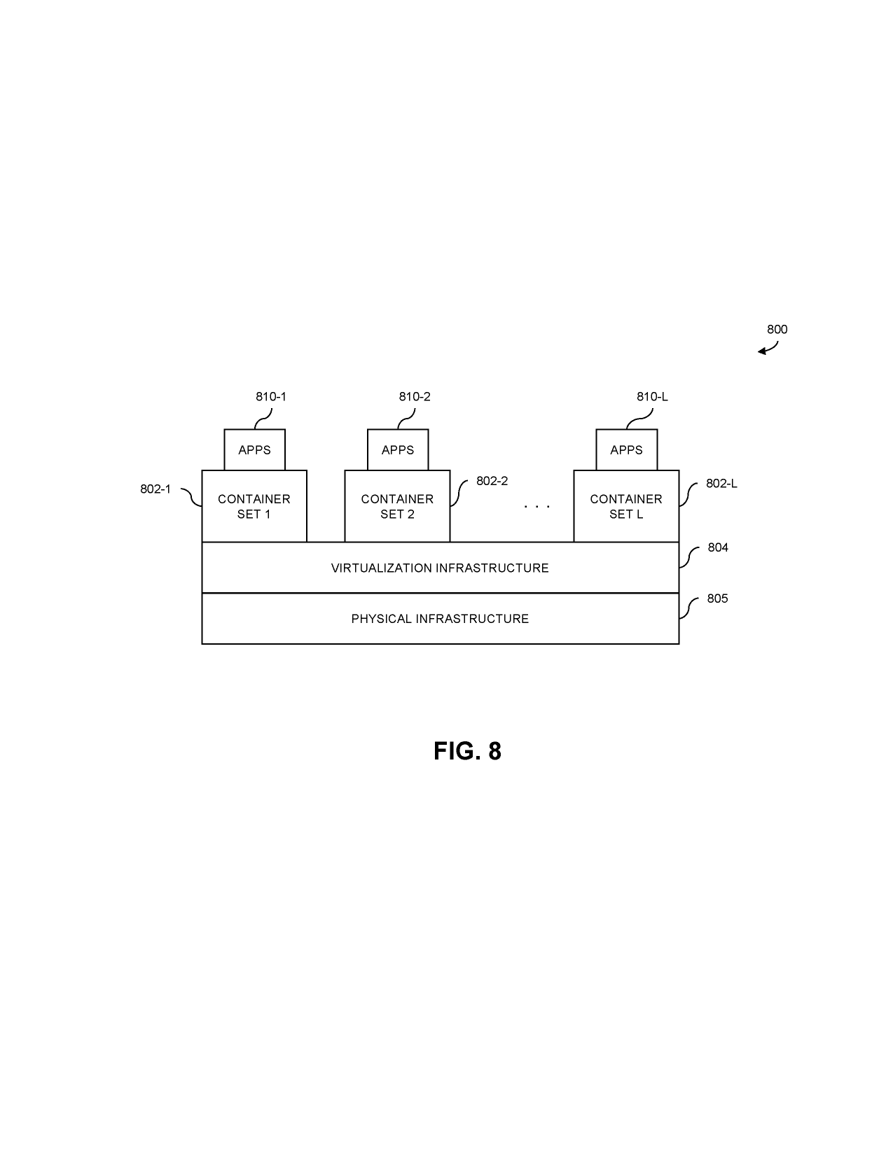

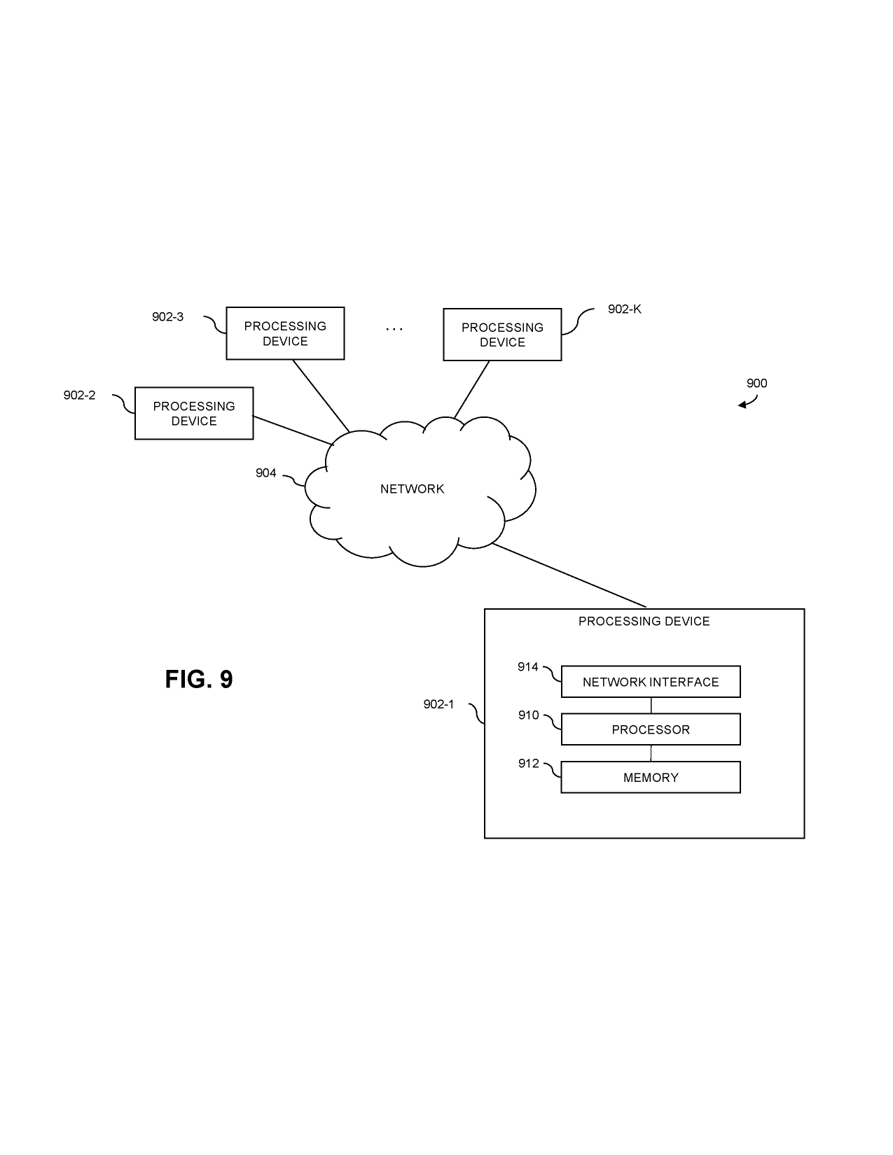

Illustrative embodiments of processing platforms utilized to implement functionality for managing usage and permissions associated with a product will now be described in greater detail with reference to FIGS. 8 and 9. Although described with regard to one or more information processing system environments mentioned herein, these platforms may also be used to implement at least portions of other information processing systems in other embodiments.

FIG. 8 shows an example processing platform comprising infrastructure 800. Infrastructure 800 comprises a combination of physical and virtual processing resources that may be utilized to implement at least a portion of an information processing system described herein. Infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

Infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. A hypervisor platform may be used to implement a hypervisor within the virtualization infrastructure 804, where the hypervisor platform has an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 800 shown in FIG. 8 may represent at least a portion of one processing platform. Another example of such a processing platform is processing platform 900 shown in FIG. 9.

The processing platform 900 in this embodiment comprises at least a portion of an information processing system and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912.

The processor 910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and information processing system environments mentioned herein may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for video management as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
extracting a set of frames from a video;
detecting one or more contextual attributes in the extracted set of frames frames, wherein the one or more contextual attributes correspond to contextual attributes associated with a plurality of contextual groups;
selecting sample frames from the extracted set of frames for each of the plurality of contextual groups for which the one or more detected contextual attributes correspond;
generating at least one classification for the video based on at least a portion of the selected sample frames; and
generating a context structure comprising the one or more detected contextual attributes and the at least one classification for the video;
wherein the above steps are performed in accordance with a processing device comprising a processor operatively coupled to a memory and configured to execute program code.

2. The method of claim 1, further comprising utilizing the context structure to respond to a contextual query searching for the video.

3. The method of claim 1, wherein the plurality of contextual groups comprise a text-oriented contextual group, a face-oriented contextual group, an object-oriented contextual group, and a color-oriented contextual group.

4. The method of claim 1, wherein the one or more detected contextual attributes comprise one or more of text appearing in the video, a face appearing in the video, an object appearing in the video, and a color appearing in the video.

5. The method of claim 1, wherein generating the at least one classification for the video based on at least a portion of the selected sample frames further comprises utilizing a long short-term memory architecture to predict the at least one classification.

6. The method of claim 5, wherein utilizing the long short-term memory architecture to predict the at least one classification further comprises implementing a temporal attention mechanism in the long short-term memory architecture to focus on the most relevant parts of the video for making a classification decision.

7. The method of claim 1, wherein generating the context structure comprising the one or more detected contextual attributes and the at least one classification for the video further comprises generating a referential context hierarchy comprising one or more metadata derived contextual references, one or more video derived contextual references, one or more audio derived contextual references, and one or more video classification references.

8. An apparatus comprising:
at least one processing platform comprising at least one processor coupled to at least one memory, the at least one processing platform, when executing program code, is configured to:
extract a set of frames from a video;
detect one or more contextual attributes in the extracted set of frames, wherein the one or more contextual attributes correspond to contextual attributes associated with a plurality of contextual groups;
select sample frames from the extracted set of frames for each of the plurality of contextual groups for which the one or more detected contextual attributes correspond;
generate at least one classification for the video based on at least a portion of the selected sample frames; and
generate a context structure comprising the one or more detected contextual attributes and the at least one classification for the video.

9. The apparatus of claim 8, wherein the at least one processing platform is further configured to utilize the context structure to respond to a contextual query searching for the video.

10. The apparatus of claim 8, wherein the plurality of contextual groups comprise a text-oriented contextual group, a face-oriented contextual group, an object-oriented contextual group, and a color-oriented contextual group.

11. The apparatus of claim 8, wherein the one or more detected contextual attributes comprise one or more of text appearing in the video, a face appearing in the video, an object appearing in the video, and a color appearing in the video.

12. The apparatus of claim 8, wherein generating the at least one classification for the video based on at least a portion of the selected sample frames further comprises utilizing a long short-term memory architecture to predict the at least one classification.

13. The apparatus of claim 12, wherein utilizing the long short-term memory architecture to predict the at least one classification further comprises implementing a temporal attention mechanism in the long short-term memory architecture to focus on the most relevant parts of the video for making a classification decision.

14. The apparatus of claim 8, wherein generating the context structure comprising the one or more detected contextual attributes and the at least one classification for the video further comprises generating a referential context hierarchy comprising one or more metadata derived contextual references, one or more video derived contextual references, one or more audio derived contextual references, and one or more video classification references.

15. A computer program product comprising a non-transitory processor-readable storage medium having stored therein program code of one or more software programs, wherein the program code when executed by at least one processing device causes the at least one processing device to:
extract a set of frames from a video;
detect one or more contextual attributes in the extracted set of frames, wherein the one or more contextual attributes correspond to contextual attributes associated with a plurality of contextual groups;
select sample frames from the extracted set of frames for each of the plurality of contextual groups for which the one or more detected contextual attributes correspond;
generate at least one classification for the video based on at least a portion of the selected sample frames; and
generate a context structure comprising the one or more detected contextual attributes and the at least one classification for the video.

16. The computer program product of claim 15, further comprising utilizing the context structure to respond to a contextual query searching for the video.

17. The computer program product of claim 15, wherein the plurality of contextual groups comprise a text-oriented contextual group, a face-oriented contextual group, an object-oriented contextual group, and a color-oriented contextual group.

18. The computer program product of claim 17, wherein the one or more detected contextual attributes comprise one or more of text appearing in the video, a face appearing in the video, an object appearing in the video, and a color appearing in the video.

19. The computer program product of claim 15, wherein generating the at least one classification for the video based on at least a portion of the selected sample frames further comprises utilizing a long short-term memory architecture to predict the at least one classification, and wherein the long short-term memory architecture implements a temporal attention mechanism in the long short-term memory architecture to focus on the most relevant parts of the video for making a classification decision.

20. The computer program product of claim 15, wherein generating the context structure comprising the one or more detected contextual attributes and the at least one classification for the video further comprises generating a referential context hierarchy comprising one or more metadata derived contextual references, one or more video derived contextual references, one or more audio derived contextual references, and one or more video classification references.
